(19) United States
(12) Patent Application Publication
(10) Pub. No.: US 2008/0096761 A1
(43) Pub. Date: Apr. 24, 2008

(54) Preparation of supports for catalysts

(75) Inventors: Shahram Mihan, Bad Soden (DE); Michael Hesse, Worms (DE)

Correspondence Address: Basell USA Inc., Delaware Corporate Center II, 2 Righter Parkway, Suite #300, Wilmington, DE, 19803, US

(73) Assignee: Basell Polyolefine GmbH, Wesseling (DE)

(21) Appl. No.: 10/588,390

(22) PCT Filed: Feb. 2, 2005
(86) PCT No.: PCT/EP05/01030

§ 371 Date: Aug. 4, 2006

Related U.S. Application Data
(60) Provisional application No. 60/556,272, filed on Mar. 24, 2004.

(30) Foreign Application Priority Data
Feb. 6, 2004 (DE) 10 2004 006 113.0

(51) Int. Cl. B01J 32/00

(52) U.S. Cl. 502/439

(57) ABSTRACT

The invention relates to a process for preparing a support for catalysts, which comprises:
a) preparing a hydrogel;
b) milling the hydrogel to give a finely particulate hydrogel;
c) producing a slurry based on the finely particulate hydrogel;
d) drying the slurry comprising the finely particulate hydrogel to give the support for catalysts,
   wherein a finely particulate hydrogel in which
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm,
   is produced in step b).

This application is the U.S. national phase of International Application PCT/EP2005/001030, filed Feb. 2, 2005, claiming priority to German Patent Application 102004006113.0 filed Feb. 6, 2004, and the benefit under 35 U.S.C. 119(e) of U.S. Provisional Application No. 60/556,272, filed Mar. 24, 2004; the disclosures of International Application PCT/EP2005/001030, German Patent Application 102004006113.0 and U.S. Provisional Application No. 60/556,272, each as filed, are incorporated herein by reference.

The present invention relates to a process for preparing a support for catalysts and to the corresponding support for catalysts.

Polymerizations are frequently carried out industrially as gas-phase or suspension polymerizations, for which homogeneous catalysts have only limited suitability. Agglomeration frequently occurs, with the consequence that the catalyst is deposited, for example, on the reactor walls, etc. Furthermore, homogeneous catalysts give fine polymer powders which cannot be conveyed. These can easily become electrostatically charged, which can lead to dust explosions. For this reason, supported catalysts have been developed.

Polymerization catalysts comprising inorganic compounds such as silicon oxides or aluminum oxides, for example silica gel or modified silica gel, as support material play an important role in the preparation of polymers. The composition of the support material has, like that of the catalyst, a critical influence on the performance of the catalyst in the polymerization process, the activity of the catalyst and the structure and properties of the polymer formed.

A disadvantage encountered when using supports rather than a homogeneous polymerization is a reduction in the activity of the catalyst. Granular supports known from the prior art have, for example, a low productivity and a high fines content, which leads to an uneconomical process.

Processes for preparing silica gels as support material for catalysts are well known in the prior art. A basic process for preparing a support material and a catalyst for the polymerization of unsaturated compounds is disclosed, for example, in DE-A 25 40 279. This starts out from a spherical silica hydrogel which has a particle diameter of from 1 mm to 8 mm.

WO 97/48742 discloses loosely aggregated catalyst support compositions which have a particle size of from 2 μm to 250 μm and a specific surface area of from 100 m²/g to 1000 m²/g, with the support particles comprising particles of an inorganic oxide having a mean particle size of less than 30 μm and a binder which loosely binds these particles to one another.

WO 97/48743 relates to fragile, agglomerated catalyst support particles which have a mean particle size of from 2 μm to 250 μm and a specific surface area of from 1 m²/g to 1000 m²/g and are prepared by spray drying primary particles having a mean particle size of from 3 μm to 10 μm. The primary particles for producing the agglomerated catalyst support particles are provided as a slurry of dry and optionally wet-milled inorganic oxide particles in water.

EP 1 120 158 discloses catalyst systems of the Ziegler-Natta type which comprise, as support, a particulate inorganic oxide consisting of particles which are composed of primary particles having a mean particle diameter in the range from 1 μm to 10 μm and have voids between the primary particles.

Disadvantages of the fragile agglomerated catalyst support particles are, in particular, that they produce polymers whose fines content is very high. The term “fines content” refers to the fraction of the polymer having a particle size of less than 250 μm.

A high fines content can lead to drawbacks in the polymerization process, for example in the reactor or in depressurization, to poor handlability of the polymer, for example during transport, and to problems with the polymer product, for example in respect of flowability.

For example, a high fines content can lead to the fines being able to become electrically charged in the reactor so that deposits are formed in the reactor or the fines can, particularly in gas-phase processes, accumulate in, for example, lines, especially the discharge lines, and block these. This can necessitate shutdown of the plant. Furthermore, a high fines content can, especially in suspension processes, lead to problems in, for example, the downstream region. Thus, a high fines content can lead to the fines together with solvents such as hydrocarbons or, for example, with hexane added to the polymerization causing conglutination of the polymer, for example in the depressurization vessel.

Furthermore, a high fines content can adversely affect transport of the polymer, in particular in the case of pneumatic transport. In addition, a high fines content in transport lines or during storage of the polymers, for example in hoppers, can lead to separation of the fines or electrostatic charging. Electrostatic charging can lead to dust explosions during transport or storage of the polymer. Furthermore, a high fines content can adversely affect the flowability or trickling properties of the polymer. For example, impaired flowability can cause problems in the extruder, in particular at the extruder screws.

It is an object of the present invention to provide a process for preparing supports for catalysts and supports for catalysts themselves which overcome at least one of the abovementioned disadvantages of the prior art.

We have found that this object is achieved by a process for preparing a support for catalysts, which comprises:
a) preparing a hydrogel:
b) milling the hydrogel to give a finely particulate hydrogel;
c) producing a slurry based on the finely particulate hydrogel;
d) drying the slurry comprising the finely particulate hydrogel to give the support for catalysts,
   wherein a finely particulate hydrogel in which
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm,
   is produced in step b).

Advantageous embodiments of the process of the present invention are set forth in the subordinate claims.

The invention further provides supports for catalysts which can be prepared according to the present invention and also provides for their use for preparing supported catalysts, in particular for the polymerization and/or copolymerization of olefins.

For the purposes of the present invention, supports are the particles which can be produced in accordance with the process of the present invention. These particles can serve as supports for catalysts. Furthermore, the particles which can be prepared according to the present invention can themselves have catalytic activity.

For the purposes of the present invention, the particles produced in step b) are preferably hydrogel particles and not xerogel particles or oxide particles. Data relating to particle size, diameter or the mean particle size are based on hydrogel particles.

Hydrogels are water-containing gels of inorganic hydroxides, preferably those based on silicon which are present as a three-dimensional network. Xerogels are gels from which water has been withdrawn, for example by solvent exchange or drying, so that the water content of the gel is less than 40% by weight, based on the total weight of the gel.

The water content of the hydrogel which can be prepared according to the present invention is preferably at least 80% by weight, more preferably at least 90% by weight, based on the total weight of the hydrogel.

For the purposes of the present invention, the term “hydrogel” refers to all hydrogels which are suitable for producing supports, preferably those based on inorganic hydroxides. The term “hydrogel” preferably refers to hydrogels based on silicon-containing starting materials, particularly preferably to hydrogels based on silica.

The preparation of a silica hydrogel is preferably carried out by acidic or basic precipitation from water glass. The hydrogel is preferably prepared by introducing a sodium or potassium water glass solution into a twisting stream of a mineral acid, e.g. sulfuric acid. The silica hydrosol formed is subsequently sprayed into a gaseous medium by means of a nozzle. The nozzle end used here leads, after allowing the hydrosol to solidify in the gaseous medium, to hydrogel particles having a mean particle size which can be varied in a range from, for example, 1 mm to 20 mm by selection of the nozzle. The hydrogel particles preferably have a mean particle size in the range from 2 mm to 10 mm, more preferably in the range from 5 mm to 6 mm. Washing of the hydrogel particles can be carried out in any way, preferably with weakly ammoniacal water having a temperature of about 50° C.-80° C. in a continuous countercurrent process.

In a preferred embodiment, the hydrogel particles can optionally be subjected to an aging step in the range from 1 hour to 100 hours, preferably in the range from 5 hours to 30 hours, prior to washing and/or after washing with the alkaline solution, which enables pore volume, surface area and/or mean pore radius of the support to be adjusted.

The hydrogel particles can be sieved and fractions having a preferred diameter isolated.

The hydrogel according to the present invention is preferably not formed from a slurry of oxides and/or xerogels in water or another solvent. A hydrogel which can be used according to the present invention is preferably a silica hydrogel prepared by a process as described above.

Apart from spray drying a hydrosol, it is likewise possible to use other methods known from the prior art for preparing the hydrogel. For example, hydrogels, preferably silica hydrogels, which can be prepared in a manner known from the prior art, for example from silicon-containing starting materials such as alkali metal silicates, alkyl silicates and/or alkoxysilanes, can likewise be used for preparing supports according to the present invention.

The size of the hydrogel particles which can be used can vary within a wide range, for example in a range from a few microns to a few centimeters. The size of hydrogel particles which can be used is preferably in the range from 1 mm to 20 mm, but it is likewise possible to use hydrogel cakes. It is advantageous to use hydrogel particles which have a size in the range ≦6 mm. These are obtained, for example, as by-product in the production of granular supports.

Hydrogels which can be prepared according to step a) are preferably substantially spherical. Furthermore, hydrogels which can be prepared according to step a) preferably have a smooth surface. Silica hydrogels which can be prepared according to step a) preferably have a solids content in the range from 10% by weight to 25% by weight, preferably in the region of 17% by weight, calculated as SiO₂.

The finely particulate hydrogel produced in step b) preferably has a solids content in the range from >0% by weight to ≦25% by weight, more preferably in the range from 5% by weight to 15% by weight, in particular in the range from 8% by weight to 13% by weight, particularly preferably in the range from 9% by weight to 12% by weight, very particularly preferably in the range from 10% by weight to 11% by weight, calculated as oxide. Particular preference is given to producing a finely particulate silica hydrogel having a solids content in the range from >0% by weight to ≦25% by weight, preferably in the range from 5% by weight to 15% by weight, more preferably in the range from 8% by weight to 13% by weight, particularly preferably in the range from 9% by weight to 12% by weight, very particularly preferably in the range from 10% by weight to 11% by weight, calculated as SiO₂, in step b). The solids content is preferably set by dilution, for example by addition of deionized water.

The hydrogel is milled to give a finely particulate hydrogel. According to the present invention, the hydrogel is milled to give very fine particles. According to the present invention, a hydrogel in which
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm,
   is produced in step b).

When, for the purposes of the present invention, mention is made of % by volume or % by weight, it goes without saying that the respective proportions in % by volume or % by weight are chosen so that they do not exceed 100% by volume or 100% by weight, based on the respective total composition.

The advantages of the support which can be prepared from hydrogel particles which have been milled according to the present invention result from the support preferably having a compact microstructure. Without being tied to a particular theory, it is assumed that the hydrogel particles according to the present invention can be agglomerated in a high packing density in the formation of the support.

Catalyst systems comprising supports which can be prepared according to the present invention from hydrogel particles which can be produced according to step b) advantageously have a particularly good productivity.

A preferred particle size distribution of the finely particulate hydrogel is one in which at least 75% by volume, preferably at least 80% by volume, more preferably at least 90% by volume, of the hydrogel particles, based on the total volume of the particles, have a particle size in the range from >0 μm to ≦35 μm, preferably in the range from >0 μm to ≦30 μm, more preferably in the range from >0 μm to ≦25 μm, in particular in the range from >0 μm to ≦20 μm, more preferably in the range from >0 μm to ≦18 μm, even more preferably in the range from >0 μm to ≦16 μm, particularly preferably in the range from >0 μm to ≦15 μm, more particularly preferably in the range from >0 μm to ≦14 μm, very particularly preferably in the range from >0 μm to ≦13 μm, especially preferably in the range from >0 μm to ≦12 μm, most preferably in the range from >0 μm to ≦11 μm.

A more preferred particle size distribution of the finely particulate hydrogel is one in which at least 75% by volume, preferably at least 80% by volume, more preferably at least 90% by volume, of the hydrogel particles, based on the total volume of the particles, have a particle size in the range from >0.1 μm to ≦35 μm, preferably in the range from ≧0.1 μm to ≦30 μm, more preferably in the range from ≧0.1 μm to ≦25 μm, in particular in the range from ≧0.1 μm to ≦20 μm, more preferably in the range from ≧0.1 μm to ≦18 μm, even more preferably in the range from ≧0.1 μm to ≦16 μm, particularly preferably in the range from ≧0.1 μm to ≦15 μm, more particularly preferably in the range from ≧0.1 μm to ≦14 μm, very particularly preferably in the range from ≧0.1 μm to ≦13 μm, especially preferably in the range from ≧0.1 μm to ≦12 μm, most preferably in the range from ≧0.1 μm to ≦11 μm.

A particularly preferred particle size distribution of the finely particulate hydrogel is one in which at least 75% by volume, preferably at least 80% by volume, more preferably at least 90% by volume, of the hydrogel particles, based on the total volume of the particles, have a particle size in the range from ≧0.2 μm to ≦35 μm, preferably in the range from ≧0.2 μm to ≦30 μm, more preferably in the range from ≧0.2 μm to ≦25 μm, in particular in the range from ≧0.2 μm to ≦20 μm, more preferably in the range from ≧0.2 μm to ≦18 μm, even more preferably in the range from ≧0.2 μm to ≦16 μm, particularly preferably in the range from ≧0.2 μm to ≦15 μm, more particularly preferably in the range from ≧0.2 μm to ≦14 μm, very particularly preferably in the range from ≧0.2 μm to ≦13 μm, especially preferably in the range from ≧0.2 μm to ≦12 μm, most preferably in the range from ≧0.2 μm to ≦11 μm.

The supports which can be prepared from the hydrogel particles according to the present invention preferably have a high homogeneity. A high homogeneity of the support can lead to the application of a catalyst to the support likewise being able to be carried out very homogeneously and the polymerization products being able to have higher molecular weights.

It is preferred that the finely particulate hydrogel has a narrow distribution of the particle sizes. For example, at least 40% by volume, preferably at least 50% by volume, of the hydrogel particles, based on the total volume of the particles, can have a particle size in the range from >0 μm to ≦10 μm, preferably in the range from >0 μm to ≦8 μm, more preferably in the range from >0 μm to ≦7 μm, particularly preferably in the range from >0 μm to ≦6.5 μm, more particularly preferably in the range from >0 μm to ≦6 μm, very particularly preferably in the range from >0 μm to ≦5.5 μm, especially preferably in the range from >0 μm to ≦5 μm, most preferably in the range from >0 μm to ≦4.5 μm.

Further preference is given to at least 40% by volume, preferably at least 50% by volume, of the hydrogel particles, based on the total volume of the particles, having a particle size in the range from ≧0.1 μm to ≦10 μm, preferably in the range from ≧0.1 μm to ≦8 μm, more preferably in the range from ≧0.1 μm to ≦7 μm, particularly preferably in the range from ≧0.1 μm to ≦6.5 μm, more particularly preferably in the range from ≧0.1 μm to ≦6 μm, very particularly preferably in the range from ≧0.1 μm to ≦5.5 μm, especially preferably in the range from ≧0.1 μm to ≦5 μm, most preferably in the range from ≧0.1 μm to ≦4.5 μm.

Furthermore, preferably at least 40% by volume, preferably at least 50% by volume, of the hydrogel particles, based on the total volume of the particles, advantageously have a particle size in the range from ≧0.2 μm to ≦10 μm, preferably in the range from ≧0.2 μm to ≦8 μm, more preferably in the range from ≧0.2 μm to ≦7 μm, particularly preferably in the range from ≧0.2 μm to ≦6.5 μm, more particularly preferably in the range from ≧0.2 μm to ≦6 μm, very particularly preferably in the range from ≧0.2 μm to ≦5.5 μm, especially preferably in the range from ≧0.2 μm to ≦5 μm, most preferably in the range from ≧0.2 μm to ≦4.5 μm.

It is advantageous for at least 5% by volume, preferably at least 7.5% by volume, particularly preferably at least 10% by volume, of the hydrogel particles, based on the total volume of the particles, to have a particle size in the range from >0 μm to ≦2.8 μm, particularly preferably from >0 μm to ≦2.5 μm. It is particularly advantageous for at least 5% by volume, preferably at least 7.5% by volume, particularly preferably at least 10% by volume, of the hydrogel particles, based on the total volume of the particles, to have a particle size in the range from >0 μm to ≦2.4 μm, preferably in the range from >0 μm to ≦2.2 μm, particularly preferably in the range from >0 μm to ≦2.0 μm, more preferably in the range from >0 μm to ≦1.8 μm, even more preferably in the range from >0 μm to ≦1.6 μm, very particularly preferably in the range from >0 μm to ≦1.5 μm.

It is even more advantageous for at least 5% by volume, preferably at least 7.5% by volume, particularly preferably at least 10% by volume, of the hydrogel particles, based on the total volume of the particles, to have a particle size in the range from ≧0.1 μm to ≦2.8 μm, particularly preferably from ≧0.1 μm to ≦2.5 μm. It is particularly advantageous for at least 5% by volume, preferably at least 7.5% by volume, particularly preferably at least 10% by volume, of the hydrogel particles, based on the total volume of the particles, to have a particle size in the range from ≧0.1 μm to ≦2.4 μm, preferably in the range from ≧0.1 μm to ≦2.2 μm, particularly preferably in the range from ≧0.1 μm to ≦2.0 μm, more preferably in the range from ≧0.1 μm to ≦1.8 μm, even more preferably in the range from ≧0.1 μm to ≦1.6 μm, very particularly preferably in the range from ≧0.1 μm to ≦1.5 μm.

It is particularly advantageous for at least 5% by volume, preferably at least 7.5% by volume, particularly preferably at least 10% by volume, of the hydrogel particles, based on the total volume of the particles, to have a particle size in the range from ≧0.2 μm to ≦2.8 μm, particularly preferably from ≧0.2 μm to ≦2.5 μm. It is particularly advantageous for at least 5% by volume, preferably at least 7.5% by volume, particularly preferably at least 10% by volume, of the hydrogel particles, based on the total volume of the particles, to have a particle size in the range from ≧0.2 μm to ≦2.4 μm, preferably in the range from ≧0.2 μm to ≦2.2 μm, particularly preferably in the range from ≧0.2 μm to ≦2.0 μm, more preferably in the range from ≧0.2 μm to ≦1.8 μm, even more preferably in the range from ≧0.2 μm to ≦1.6 μm, very particularly preferably in the range from ≧0.2 μm to ≦1.5 μm. It is especially advantageous for at least 10% by volume of the hydrogel particles, based on the total volume of the particles, to have a particle size in the range from ≧0.5 μm to ≦3 μm, more preferably in the range from ≧0.5 μm to ≦2.5 μm.

Preference is given to a finely particulate hydrogel which has a preferably narrow particle size distribution in which
at least 10% by volume of the particles, based on the total volume of the particles, have a particle size in the range from >0 μm to ≦2.5 μm, preferably in the range from >0 μm to ≦2.0 μm, more preferably in the range from >0 μm to ≦1.8 μm, particularly preferably in the range from >0 μm to ≦1.6 μm; and/or
at least 50% by volume of the particles, based on the total volume of the particles, have a particle size in the range from >0 μm to ≦8 μm, preferably in the range from >0 μm to ≦7 μm, more preferably in the range from >0 μm to ≦5 μm, particularly preferably in the range from >0 μm to ≦4 μm, and/or
at least 90% by volume of the particles, based on the total volume of the particles, have a particle size in the range from >0 μm to ≦21 μm, preferably in the range from >0 μm to ≦16 μm, more preferably in the range from >0 μm to ≦14 μm, particularly preferably in the range from >0 μm to ≦12 μm,
   being produced in step b).

Furthermore,
at least 5% by volume of the particles, based on the total volume of the particles, can have a particle size in the range ≧2 μm; and/or
at least 10% by volume of the particles, based on the total volume of the particles, can have a particle size in the range ≧1 μm.

The hydrogel can have a mean particle size in the range from ≧1 μm to ≦8 μm. The hydrogel preferably has a mean particle size in the range from ≧1.2 μm to ≦6 μm, more preferably in the range from ≧1.5 μm to ≦5 μm, particularly preferably in the range from ≧2 μm to ≦4 μm.

The quoted particle sizes according to the present invention relate to hydrogel particles in the sense of the invention, preferably not to particles of a gel from which water has been withdrawn or an oxide. The size of the hydrogel particles can be reduced by drying of a gel to down to one-tenth of the size of the undried hydrogel. The quoted sizes of the hydrogel particles according to the present invention preferably relate to a hydrogel from which no water has been withdrawn before it is milled. The particle sizes quoted preferably do not relate to particles which have been formed from a slurry of inorganic oxides, oxide-hydroxides and/or xerogels in water or another solvent. The indicated sizes of the hydrogel particles which can be prepared according to the present invention thus preferably relates to particles which are significantly different from the particles used in the prior art.

According to the present invention, preference is given to milling a hydrogel in step b). During this milling step, additions of inorganic oxides, oxide-hydroxides and/or xerogels can be added to the hydrogel. The hydrogel is preferably milled moist and/or wet to give a finely particulate hydrogel. Moist or wet milling relates to the milling of a hydrogel which is preferably not dried up to the point of milling and/or from which preferably no water has been withdrawn prior to milling. Furthermore, the conditions of the milling step are selected so that preferably no water is withdrawn from the hydrogel during the milling process. The hydrogel is preferably not dry milled in step b).

“Oxide-hydroxides” are, for the purposes of the present invention, compounds which have a lower water content than a hydrogel without the water having been withdrawn from the compound to form the corresponding oxide.

Milling of the hydrogel can be carried out in a suitable mill, for example in a pin mill or an impingement plate mill; the hydrogel is preferably milled wet in a stirred ball mill. The milling of the hydrogel can be carried out in one step and/or in one mill or in a plurality of steps and/or in different mills. Before the hydrogel is finely milled, the hydrogel can be subjected to preliminary crushing or preliminary milling.

The advantageous properties of the support for catalysts result from the hydrogel particles being finely milled according to the present invention. The supports which can be prepared by the process of the present invention lead, after application of catalyst compounds, to supported catalysts which, in preferred embodiments, have a surprisingly high productivity. This is particularly surprising since, according to general teachings, very small, finely milled hydrogel particles lead to support particles which have a very high packing density, which would cause a decrease in the productivity of the catalyst.

The finely particulate hydrogel particles can be sieved after milling. The finely particulate hydrogel is converted into a slurry comprising finely particulate moist hydrogel, preferably silica hydrogel. The production of a slurry can, for example, comprise setting of the solids content, setting of the pH, setting of the viscosity, addition of hydroxides, oxide-hydroxides, oxides and/or salts, additives and/or fillers.

In advantageous embodiments, additives can be added to the slurry and/or the hydrogel in step b), in particular prior to milling. Addition in step b) preferably means, for the purposes of the present invention, that the additives are preferably added prior to milling and are preferably milled together with the hydrogel. The addition of materials selected from the group consisting of hydroxides, oxide-hydroxides, oxides and/or salts, additives and/or fillers and/or adjustment of the pH can advantageously be provided in step b) of the process of the present invention.

Suitable inorganic hydroxides, oxide-hydroxides and/or oxides are, for example, selected from the group consisting of hydroxides, oxide-hydroxides and oxides of silicon, aluminum, titanium, zirconium and metals of main group I or II of the Periodic Table and mixtures thereof. Preference is given to adding inorganic hydroxides, oxide-hydroxides, oxides and/or salts, preferably selected from the group consisting of SiO₂, Al₂O₃, MgO, AlPO₄, TiO₂, ZrO₂, Cr₂O₃ and mixtures thereof to the hydrogel in step b) and/or the slurry in step c). Very particular preference is given to inorganic hydroxides, oxide-hydroxides, oxides and/or salts selected from the group consisting of Al₂O₃, AlOOH, AlPO₄ and ZrO₂. Magnesium oxide and/or sheet silicates are also preferred. It is also possible to use mixed oxides such as aluminum silicates or magnesium silicates. It is possible to add freshly prepared hydroxides, oxide-hydroxides, oxides and/or salts, but also commercially available compositions. Preference is given to adding wet-milled, inorganic hydroxides, oxide-hydroxides and/or oxides to the hydrogel and/or the slurry. The process of the present invention can also provide for the hydrogel and/or the slurry to be produced without addition of dry-milled inorganic oxides selected from the group consisting of SiO₂, Al₂O₃, MgO, AlPO₄, TiO₂, ZrO₂, Cr₂O₃ and mixtures thereof.

The proportion of hydroxides, oxide-hydroxides, oxides and/or salts which can be added can vary within a wide range. The proportion of hydroxides, oxide-hydroxides, oxides and/or salts which can be added is preferably in the range from 1% by weight to 70% by weight, based on the total solids content of the hydrogel and/or the slurry. Preference is given to adding inorganic hydroxides, oxide-hydroxides, oxides and/or salts to the hydrogel in step b) and/or to the slurry in step c) in an amount of ≦10% by weight, preferably ≦5% by weight, particularly preferably ≦2% by weight, based on the total solids content. Aluminum compounds can advantageously be added in higher proportions by weight.

According to the present invention, preference is given to adding compounds of aluminum, for example AlOOH (pseudoboehmite), AlPO₄ and/or Al₂O₃, to the hydrogel and/or the slurry. Preference is given to adding AlOOH to the hydrogel in step b) and/or to the slurry in step c) in an amount of from 1% by weight to 30% by weight, preferably from 5% by weight to 20% by weight, based on the total solids content. Further preference is given to adding AlOOH to the hydrogel and/or the slurry in an amount of from 3% by weight to 18% by weight, preferably from 5% by weight to 15% by weight, more preferably from 6% by weight to 12% by weight, particularly preferably from 6% by weight to 10% by weight, based on the total solids content.

The % by weight figures quoted for the addition of hydroxide compounds, in particular AlOOH, is, unless indicated otherwise, calculated as the oxide, in particular Al₂O₃, and based on the total solids content calculated as oxide.

Furthermore, Al₂O₃ can be added to the hydrogel in step b) and/or to the slurry in step c) in an amount of from 1% by weight to 30% by weight, preferably from 5% by weight to 20% by weight, based on the total solids content. Further preference is given to adding Al₂O₃ to the hydrogel and/or the slurry in an amount of from 3% by weight to 18% by weight, preferably from 5% by weight to 15% by weight, more preferably from 6% by weight to 12% by weight, particularly preferably from 6% by weight to 10% by weight, based on the total solids content. Aluminum compounds can, for example, be added in the form of the commercially available products Pural SB, Disperal and/or Apyral, obtainable from the companies Sasol Ltd. and Nabaltec GmbH.

AlPO₄ can be added to the hydrogel and/or the slurry in widely varying proportions by weight, for example in amounts of from 30% by weight to 70% by weight, based on the total solids content.

Furthermore, hydroxides, oxide-hydroxides and/or oxides of zirconium, for example zirconium hydroxide and/or ZrO₂, can be added to the hydrogel and/or the slurry. Zirconium hydroxide and/or ZrO₂ is preferably milled wet. Preference is given to adding ZrO₂ to the hydrogel and/or the slurry in an amount of from 1% by weight to 10% by weight, preferably from 2% by weight to 6% by weight, based on the total solids content.

The hydroxides, oxide-hydroxides and/or oxides which can be added are preferably milled wet. Furthermore, the hydroxides, oxide-hydroxides and/or oxides preferably have a mean particle size in the range from 1 μm to 10 μm. The hydroxides, oxide-hydroxides and/or oxides can be milled together with the hydrogel in step b) and/or can be milled separately, preferably wet, but it can also be provided according to the present invention for the slurry comprising the finely milled hydrogel and hydroxides, oxide-hydroxides and/or oxides which can optionally be added to be milled in step c), preferably milled wet. The milling of the hydrogel and/or the slurry can be repeated a number of times.

In preferred embodiments, compounds of the alkaline earth metals, preferably compounds selected from the group consisting of hydroxides and oxides of alkaline earth metals, for example compounds selected from the group consisting of magnesium hydroxide, calcium hydroxide, magnesium oxide and calcium oxide, can be added in step b). Preference is given to adding Ca(OH)₂ and/or Mg(OH)₂ to the hydrogel in step b) in amounts of from 1% by weight to 10% by weight, preferably from 2% by weight to 4% by weight, based on the total solids content.

Furthermore, large organic molecules, for example polymers, hydroxycellulose, polyethylene glycol, polyamines, anionic and/or cationic surfactants, can be added to the slurry and/or the hydrogel, in particular as templates for optimizing the support structure by forming voids after calcination, preferably in an oxidizing atmosphere.

Preference is given to producing an aqueous slurry in step c). The solvent of the hydrogel in step b) and/or of the slurry in step c) can, however, be replaced at least partially; for example, the hydrogel and/or the aqueous slurry can comprise organic solvents, for example aliphatic alcohols, preferably toluene and/or a methanol/glycerol mixture. Replacement of the solvent preferably comprises replacement of up to 50% by weight, based on the total weight of the hydrogel and/or the slurry, of water. The hydrogel in step b) and/or the slurry in step c) preferably has a water content of at least about 50% by weight, based on the total weight of the hydrogel and/or the slurry. Spray drying of the support particles is preferably carried out, for example, from an aqueous solution, but it can be advantageous for at least part of the solvent to be replaced prior to spray drying.

The pH of the hydrogel in step b) and/or the slurry in step c) can vary, but the pH of the hydrogel and/or the slurry is preferably in the neutral to basic range. The pH of the hydrogel and/or the slurry can advantageously be set to values in the range from 8 to 11, and the pH of the slurry after the adjustment is preferably in the range from 8 to 10. The adjustment of the pH of the hydrogel and/or the slurry can be carried out by means of suitable acids or bases, preferably by means of NH₄OH.

It is also possible for a binder which can aid the particle formation process, for example during spray drying, and/or improve the cohesion of the particles to be added to the hydrogel in step b) and/or to the slurry in step c). Binders used can be particularly fine, e.g. colloidal, particles of inorganic oxides. However, it is also possible to add auxiliaries, for example polymers such as cellulose derivatives, polystyrene and/or polymethyl methacrylate as binders. It is advantageous to add hydroxymethylcellulose to the hydrogel in step b) and/or to the slurry in step c), preferably in an amount of from 0.1% by weight to 10% by weight, particularly preferably from 1% by weight to 2% by weight, based on the total solids content.

The viscosity of the slurry in step c) can advantageously be modified. The viscosity of the slurry can be increased, for example, by addition of compounds of the alkaline earth metals, preferably compounds selected from the group consisting of hydroxides and oxides of alkaline earth metals, for example compounds selected from the group consisting of magnesium hydroxide, calcium hydroxide, magnesium oxide and calcium oxide. Preference is given to adding Ca(OH)₂ and/or Mg(OH)₂ to the slurry in step c) in amounts of from 1% by weight to 10% by weight, preferably from 2% by weight to 4% by weight, based on the total solids content. The viscosity of the slurry has, for example, a significant effect on the particle size of the support particles produced by spray drying.

An important factor in the preparation of the support for catalysts is the solids content of the slurry. It is usual to use high solids contents in the range from 10% by weight to 25% by weight, based on the total weight. According to the present invention, the solids content of the slurry is set to ≦20% by weight, preferably ≦15% by weight, more preferably ≦12% by weight, particularly preferably ≦10% by weight, more particularly preferably in the range from 5% by weight to 10% by weight, very particularly preferably in the range from 8% by weight to 10% by weight, based on the total weight, in step c) prior to drying.

Surprisingly, a low solids content of the slurry leads to support particles which have particularly advantageous particle diameters.

The size of the particles can be adjusted again before drying, for example by filtering and/or sieving the slurry, for example via a sieve of suitable size.

The order in which the process steps a) to d) are carried out is, according to the present invention, not restricted to the order described, but preference is given to carrying out the steps in the order indicated.

Drying of the slurry comprising the finely particulate hydrogel to give the support is preferably carried out by spray drying. However, it can also be preferred according to the present invention for drying to be carried out by other methods, for example by thermal drying, drying under reduced pressure and/or by extraction of the water by means of an organic solvent. Furthermore, drying of the slurry comprising the finely particulate hydrogel can also be carried out by means of a combination of suitable methods. Furthermore, the spray-dried support particles can, for example, be additionally dried thermally. Drying of the slurry comprising the finely particulate hydrogel is preferably carried out by means of spray drying.

The support particles are preferably produced by spray drying the slurry comprising the finely particulate hydrogel. The spray drying conditions can be varied within a wide range. The properties of the support particles after spray drying are determined largely by the properties of the slurry, so that the individual spray-drying parameters are not particularly critical in determining the properties of the support. The settings for the spray-drying parameters in order to achieve the desired properties of the support particles, e.g. temperature, gas flow, gas inlet and outlet temperature and/or initial and final moisture content, are known to those skilled in the art and are selected according to the nature of the apparatus.

The support particles which can advantageously be produced by spray drying generally have a spheroidal, i.e. sphere-like, shape. The desired mean particle size of the supports after spray drying can be varied within a wide range and can be matched appropriately to the use of the supports. The mean particle size of the supports can thus be set, for example, to meet the requirements of various polymerization processes.

The support particles which are preferably produced by means of spray drying preferably have a mean particle size in the range from 1 μm to 350 μm, preferably in the range from 30 μm to 150 μm and particularly preferably in the range from 40 μm to 100 μm. The support particles which are preferably produced by means of spray drying particularly preferably have a mean particle size in the range from 30 μm to 90 μm, more preferably in the range from 40 μm to 70 μm, particularly preferably in the range from 40 μm to 50 μm and very particularly preferably in the range from 40 μm to 55 μm.

It is particularly preferred that from 70% by volume to 90% by volume of the support particles, preferably 80% by volume of the particles, based on the total volume of the particles, have a mean particle size in the range from ≧40 μm to ≦90 μm.

Support particles which are preferably used for polymerization by a slurry polymerization process preferably have mean particle sizes up to 350 μm and particularly preferably have a mean particle size in the range from 30 μm to 150 μm. Support particles which are preferably used for polymerization in a gas-phase fluidized-bed process preferably have a mean particle size in the range from 30 μm to 120 μm. Support particles which are preferably used for polymerization in a suspension process preferably have a mean particle size in the range from 30 μm to 300 μm. Support particles which are preferably used for polymerization in a lop process preferably have a mean particle size in the range from 30 μm to 150 μm. Support particles which can be used, for example, for polymerization in fixed-bed reactors preferably have mean particle sizes of ≧100 μm, preferably ≧300 μm, more preferably in the range from 1 mm to 10 mm, particularly preferably in the range from 2 mm to 8 mm and even more preferably in the range from 2.5 mm to 5.5 mm.

Preference is given to from 10% by volume to 90% by volume of the support particles which can be produced in step d), based on the total volume of the particles, having a particle size in the range from ≧40 μm to ≦120 μm. It is even more preferred that from 30% by volume to 80% by volume of the particles, based on the total volume of the particles, have a particle size in the range from ≧30 μm to ≦70 μm. Particular preference is given to particle sizes of the support particles in the range from ≧30 μm to 70 μm.

The support particles which can be produced in step d) preferably have a particle size distribution, in particular of the output from the spray dryer, in which ≧90% by volume, based on the total volume of the particles, of particles have a size in the range from ≧16 μm to 500 μm, ≧75% by volume of the particles have a size in the range from ≧32 μm to ≦200 μm and ≧30% by volume of the particles have a size in the range from ≧48 μm to ≦150 μm.

The support particles after drying, in particular after spray drying, particularly advantageously have a low fines content. For the purposes of the present invention, the fines content of the support particles is the proportion of support particles having a particle size of less than 25 μm, preferably less than 22 μm, particularly preferably less than 20.2 μm. It is advantageous for ≦5% by volume of the particles after drying, based on the total volume of the particles, to have a particle size in the range from >0 μm to ≦25 μm, preferably in the range from >0 μm to ≦22 μm, particularly preferably in the range from >0 μm to ≦20.2 μm. Preference is given to ≦3% by volume, particularly preferably ≦2% by volume, of the particles, based on the total volume of the particles, having a particle size in the range from >0 μm to ≦25 μm, preferably in the range from >0 μm to ≦22 μm, particularly preferably in the range from >0 μm to ≦20.2 μm. Even greater preference is given to ≦5% by volume, preferably ≦2% by volume, of the particles, based on the total volume of the particles, having a particle size in the range from >0 μm to ≦10 μm.

Furthermore, it is preferred that ≦30% by volume, preferably ≦20% by volume, particularly preferably ≦15% by volume, very particularly preferably ≦10% by volume, of the particles, based on the total volume of the particles, have a particle size in the range from >0 μm to ≦35 μm, preferably in the range from >0 μm to ≦32 μm.

A higher proportion of fines in the support particles can subsequently lead to a high fines content of the polymers produced using these supports. Thus, a great advantage of the supports used according to the present invention is realized by the support particles having a low fines content, particularly after spray drying.

It has surprisingly been found that the support particles which can be prepared according to the present invention are very compact support particles which can, after application of catalyst compounds, display a surprisingly high activity in polymerization reactions without the support particles having a very high fragility, as preferred in the prior art.

The support particles which can be prepared according to the present invention have a pore volume which is preferably in the range from 0.2 ml/g to ≦1.6 ml/g, more preferably in the range from 0.5 ml/g to ≦1.4 ml/g, particularly preferably in the range from 0.8 ml/g to 1.35 ml/g.

The support particles which can be prepared according to the present invention have a pore diameter which is preferably in the range from 10 Å to ≦200 Å, more preferably in the range from 20 Å to ≦15 Å, particularly preferably in the range from 50 Å to 130 Å.

Catalysts based on granular supports frequently have a lower productivity than those based on spray-dried supports. Furthermore, granular supports frequently have a higher strength than spray-dried supports. The surprising advantage of the supports which can be prepared according to the present invention over granular supports is that they display, in particularly preferred embodiments, a higher catalytic activity than granular supports having a comparable strength.

The surface area of the inorganic support can likewise be varied within a wide range by means of the drying step, in particular by means of the spray drying process. Preference is given to producing particles of the inorganic support, in particular a spray dryer output, which have a surface area in the range from 100 m²/g to 1000 m²/g, preferably in the range from 150 m²/g to 700 m²/g and particularly preferably in the range from 200 m²/g to 500 m²/g. Supports which can be used for polymerization preferably have a surface area in the range from 200 m²/g to 500 m²/g. The specific surface area of the support particles is, for the present purposes, the surface area of the support particles determined by means of nitrogen adsorption in accordance with the BET technique.

The bulk density of the inorganic supports for catalysts is preferably in the range from 250 g/l to 1200 g/l, and can vary as a function of the water content of the support. The bulk density of water-containing support particles is preferably in the range from 500 g/l to 1000 g/l, more preferably in the range from 600 g/l to 950 g/l and particularly preferably in the range from 650 g/l to 900 g/l. In the case of supports which contain no water or only a very small amount of water, the bulk density is preferably from 250 g/l to 600 g/l.

The support according to the present invention is preferably produced from a silica hydrogel. Consequently, the support preferably has a high SiO₂ content. The silicon content of the support is preferably ≧10% by weight, more preferably ≧15% by weight, even more preferably ≧20% by weight, particularly preferably ≧25% by weight, more particularly preferably ≧30% by weight, especially preferably ≧40% by weight, very particularly preferably ≧50% by weight, based on the total weight of support.

Aluminum can be added to the hydrogel in step b) and/or the slurry based on the finely particulate hydrogel, preferably silica hydrogel, in step c), preferably in the form of compounds selected from the group consisting of Al₂O₃, AlPO₄ and AlOOH. The aluminum content of the support is preferably ≧5% by weight, more preferably ≧10% by weight, even more preferably ≧15% by weight, very preferably ≧20% by weight, particularly preferably ≧25% by weight, very particularly preferably ≧30% by weight, especially preferably ≧40% by weight, most preferably ≧50% by weight, based on the total weight of the support.

Furthermore, zirconium compounds, preferably compounds selected from the group consisting of zirconium hydroxide, zirconium oxide-hydroxide, ZrO₂, ZrO(NO₃)₂, Zr(OR)₄ and Zr(OOCR)₄, where R is preferably selected from the group consisting of substituted or unsubstituted alkyl having from 1 to 20 carbon atoms, e.g. methyl, ethyl, n-propyl, n-butyl, tert-butyl, n-pentyl, n-hexyl, n-heptyl, n-octyl, vinyl, allyl, benzyl and/or phenyl, can be added to the hydrogel in step b) and/or to the slurry based on the finely particulate hydrogel, preferably silica hydrogel, in step c). The zirconium compounds can be milled together with the hydrogel and/or the slurry and/or be milled separately, preferably wet.

The zirconium content of the support is preferably in the range from ≧0.1% by weight to ≦10% by weight, more preferably in the range from ≧0.5% by weight to ≦5% by weight, even more preferably in the range from ≧1% by weight to ≦4% by weight, particularly preferably in the range from a ≧2% by weight to ≦3% by weight, based on the total weight of the support.

It is also possible to add titanium, preferably in the form of compounds selected from the group consisting of titanium hydroxide, titanium oxide-hydroxide, TiO₂, TiO(NO₃)₂, Ti(OR)₄ and Ti(OOCR)₄, where R is preferably selected from the group consisting of substituted or unsubstituted alkyl having from 1 to 20 carbon atoms, e.g. methyl, ethyl, n-propyl, n-butyl, tert-butyl, n-pentyl, n-hexyl, n-heptyl, n-octyl, vinyl, allyl, benzyl and/or phenyl, to the hydrogel in step b) and/or to the slurry based on the finely particulate hydrogel, preferably silica hydrogel, in step c). The titanium compounds can be milled together with the hydrogel and/or the slurry and/or be milled separately, preferably wet. The titanium content of the support is preferably in the range from ≧0.1% by weight to ≦10% by weight, more preferably in the range from ≧0.5% by weight to ≦5% by weight, even more preferably in the range from ≧1% by weight to ≦4% by weight, particularly preferably in the range from ≧2% by weight to ≦3% by weight, based on the total weight of the support.

The catalyst supports according the present invention are suitable for a variety of applications, for example as supports for hydrogenation catalysts, as supports for dehydrogenation catalysts and/or as supports for fixed-bed catalysts. For example, the catalyst supports according to the present invention are useful for hydrogenation catalysts based on impregnated ruthenium compounds for the hydrogenation of aromatic rings to aliphatic rings in the presence of polar functional groups. The catalyst supports according to the present invention are preferably used for preparing supported catalysts for the polymerization and/or copolymerization of olefins. The supports which can be prepared by the process of the present invention have a high mechanical strength and are particularly suitable for use in fluidized-bed reactors and/or stirred gas-phase reactors.

However, the supports according to the present invention are not restricted to applications in which catalyst compounds are applied. For example, the supports according to the present invention can likewise be suitable for application of substances which have no catalytic activity. Furthermore, the supports according to the present invention can likewise be suitable for use as catalysts in modern organic synthesis and industrial processes. In particular, the supports according to the present invention can themselves be used as catalysts, for example in organic reactions, i.e. the support can display catalytic properties.

The supported catalysts can be prepared, for example, by applying one or more catalyst compounds and optionally activators to a support according to the present invention. Supports according to the present invention are particularly preferably used with a catalyst suitable for the polymerization of olefins. Catalysts which can be used here are particularly preferably catalysts selected from the group consisting of Ziegler-Natta catalysts, Phillips catalysts, preferably catalysts based on chromium oxides, and/or catalyst systems having a uniquely defined active center, viz. single site catalysts, which can comprise a metal complex, for example a metallocene, chromium-, iron-, cobalt-, vanadium-, nickel- and palladium-containing systems, other transition metal systems and/or one or more activator compounds.

Suitable activator compounds and/or cocatalysts can, for example, be selected from the group consisting of aluminum compounds such as cyclic and linear aluminoxanes, for example methylaluminoxane (MAO), electron donor compounds, aluminum alkyls, boranes, boroxins, borates, alkyl compounds of lithium, magnesium or zinc, organosilicon compounds, activator compounds having strongly oxidizing properties and mixtures thereof.

Supports for catalysts can be prepared in high quality by the process of the present invention. A great advantage of the catalyst supports which can be prepared by the process of the present invention is that in preferred embodiments they have an advantageous hardness and compactness despite their porosity. The supports according to the present invention preferably have a low susceptibility to being broken and/or fragility than the supports customary in the prior art.

The advantageous properties of the catalyst supports which can be prepared by the process of the present invention can lead, for example in polymerization reactions using the supports according to the present invention in combination with a known catalyst customary for the polymerization of olefins, to the fines content of the resulting polymer being significantly reduced. The fines content of a polymer is, for the purposes of the present invention, the proportion having a particle size of less than 250 μm, and the proportion of very fine material in a polymer is the proportion having a particle size of less than 125 μm. Surprisingly, the polymers produced using supports which can be prepared according to the present invention have, in preferred embodiments, a surprisingly low proportion of polymer having a particle size of less than 250 μm 125 μm.

The very low fines contents which can be achieved in polymerization processes when using the supports which can be prepared by the process of the present invention represent a particular advantage of the present invention.

A low fines content of the polymer can lead to a polymerization product having improved properties, for example an improved film grade and/or a low level of specks in the polymer films. A low fines content of the polymer can also lead to significantly improved manageability of the polymerization process.

A further advantage of the supports according to the present invention is that, in preferred embodiments, the bulk density of the resulting polymer is significantly increased when the supports which can be prepared by the process of the present invention are used.

A further important advantage of the supports according to the present invention is, in particularly preferred embodiments, a surprisingly high activity and productivity of the catalysts supported on the supports in the polymerization and copolymerization of olefins.

Advantageously, the supports which can be prepared by the process of the present invention can make it possible to carry out polymerization reactions at a high activity and to give a polymer having a high bulk density.

The following example describes a preferred way of preparing the supports of the invention.

### EXAMPLE

1. Preparation of the support

To prepare the hydrogel, a mixing nozzle, for example as described in DE-A 21 03 243, having the following data was used: the diameter of the cylindrical mixing chamber formed by a plastic hose was 14 mm, and the length of the mixing space including the after-mixing section was 350 mm. Close to the inlet end of the mixing chamber, whose inlet end face was closed, there was a tangential inlet hole having a diameter of 4 mm for the mineral acid. Four further holes which likewise had a diameter of 4 mm and the same inlet direction for the water glass solution followed at intervals of 30 mm, measured in the longitudinal direction of the mixing chamber. The ratio of length to diameter for the primary mixing zone was therefore about 10:1. In the subsequent secondary mixing zone, this ratio was 15. As spray nozzle, a flattened, slightly kidney-shaped piece of tube was pushed over the exit end of the plastic hose.

This mixing apparatus was supplied with 325 l/h of 33 percent strength by weight of sulfuric acid at 20° C. and an operating pressure of about 3 bar and with 1100 l/h of water glass solution, which can be prepared from water glass containing 27% by weight of SiO₂ and 8% by weight of Na₂O by dilution with water, having a density of 1.20 kg/l and a temperature of likewise 20° C. and likewise under a pressure of about 3 bar. In the mixing chamber lined with the plastic hose, an unstable hydrosol having a pH of from 7 to 8 was formed as neutralization progressed and this remained for about a further 0.1 s in the after-mixing zone to achieve complete homogenization before it was sprayed into the atmosphere as a fan-shaped liquid jet through the nozzle. During its flight through the air, the jet broke up into individual droplets which as a result of the surface tension assumed a substantially spherical shape and solidified within about one second to form spherical hydrogel particles during their flight. The hydrogel particles had a smooth surface, were clear and had a solids content of about 17% by weight, calculated as SiO₂.

The hydrogel particles had the following particle size distribution: from 8% by weight to 15% by weight in the range >8 mm, from 30% by weight to 50% by weight in the range from 6 mm to 8 mm, from 20% by weight to 40% by weight in the range from 4 mm to 6 mm and from 5% by weight to 20% by weight in the range ≦4 mm.

The hydrogel particles were collected in a scrubbing tower which was filled virtually completely with hydrogel particles and in which the spheres were immediately washed free of salts without aging by means of weakly ammoniacal water at about 50° C. in a continuous countercurrent process.

Hydrogel spheres up to 20 mm were used. The solids contents of 5 equal batches of the washed silica hydrogel were each brought to about 10% by weight, calculated as SiO₂, by means of deionized water. Batches 1 to 5 of the hydrogel were each precomminuted separately in a commercial mill. Batches 1 to 5 of the hydrogel were subsequently milled very finely separately from one another in a commercial stirred ball mill. The particle sizes obtained for batches 1 to 5 are shown in table I. Here, X 10, X 50, X 90 are the particles sizes for which 10% by volume, 50% by volume and 90% by volume, respectively, of the hydrogel particles, based on the total volume of the particles, are smaller than the indicated size.

TABLE I

| | | | | Solids content |
|---|---|---|---|---|
| | X 10 μm | X 50 μm | X 90 μm | [% by weight] |
| Batch 1 | 1.86 | 5.46 | 13.63 | 10.64 |
| Batch 2 | 2.07 | 6.28 | 15.74 | 10.3 |
| Batch 3 | 2.06 | 6.24 | 15.75 | 10.78 |
| Batch 4 | 2.13 | 6.39 | 16.15 | 10.69 |
| Batch 5 | 2.22 | 6.6 | 16.71 | 11.14 |

1.1% by weight, based on the total solids content, of hydroxymethylcellulose (Walocel, obtainable from Wolff) were added to batch 1 of the finely particulate silica hydrogel from step b). 0.5% by weight, based on the total solids content, of hydroxymethylcellulose (Walocel, obtainable from Wolff) and AlOOH calculated as 6% by weight of Al₂O₃, based on the total solids content, were added to batch 2. AlOOH calculated as 6% by weight of Al₂O₃, based on the total solids content, was added to batch 3. AlOOH calculated as 12% by weight of Al₂O₃, based on the total solids content, was added to batch 4. AlOOH calculated as 18% by weight of Al₂O₃, based on the total solids content, was added to batch 5. The solids content of the slurries was in each case set to about 8% by weight, based on the total weight, by means of water.

The slurries of batches 1 to 5 were spray dried. The spray-dried batches were in each case sieved to ≦0.4 mm. The support particles of all batches had a surface area in the range from 400 m²/g to 500 m²/g, a pore volume in the range from 70 Å to 110 Å and a pore volume in the range from 0.800 ml/g to 1.200 ml/g. A particle size analysis by means of a Coulter counter indicated that the proportion of particles of all batches having a size of ≦20.2 μm was less than 2.0% by volume and the proportion of particles having a size of ≦32 μm was less than 20% by volume, based on the total volume of the particles. The mean particle size was in the range from 40 μm to 70 μm.

### Analysis

The particle size of the hydrogel particles was determined by sieve analysis using a Mastersizer S long bed Ver. 2.15, Malvern Instruments GmbH, using the following system parameters: focal length 300 RF mm, scattering model 3SSD, path length 2.40 mm, module MS17.

To determine the mean particle diameter of the support particles, the particle size distribution of the support particles was measured by Coulter counter analysis in accordance with ASTM Standard D 4438 and the volume-based mean (median) was calculated therefrom.

The pore volume was determined by means of mercury porosimetry in accordance with DIN 66133.

The determination of the surface area, the pore radius and the pore volume of the support particles is carried out by means of nitrogen adsorption using the BET technique (S. Brunauer et al., Journal of the American Chemical Society, 60, p. 209-319, 1929).

The determination of the silicon and aluminum content of the support particles was carried out by atomic emission spectroscopy using an inductively coupled plasma (ICP-AES).

1. A process for preparing a support for catalysts, which comprises:
a) preparing a hydrogel;
b) milling the hydrogel to give a finely particulate hydrogel having a solids content;
c) producing a slurry having a solids content, the slurry comprising the finely particulate hydrogel;
d) drying the slurry comprising the finely particulate hydrogel, thereby forming a support for catalysts,
wherein the finely particulate hydrogel comprises:
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm.

2. The process for preparing the support for catalysts as claimed in claim 1, wherein the finely particulate hydrogel comprising at least 90% by volume of the hydrogel particles, based on the total volume of the particles, has a particle size in the range from >0 μm to ≦35 μm.

3. The process for preparing the support for catalysts as claimed in claim 1, wherein the finely particulate hydrogel has a solids content in the range from >0% by weight to ≦25% by weight, calculated as oxide.

4. The process for preparing the support for catalysts as claimed in claim 1, wherein the finely particulate hydrogel comprising at least 40% by volume, of the hydrogel particles, based on the total volume of the particles, has a particle size in the range from >0 μm to ≦10 μm.

5. The process for preparing the support for catalysts as claimed in claim 1, wherein the finely particulate hydrogel comprising at least 10% by volume of the hydrogel particles, based on the total volume of the particles, has a particle size in the range from >0 μm to ≦2.8 μm.

6. The process for preparing the support for catalysts as claimed in claim 1, wherein inorganic hydroxides, oxide-hydroxides, oxides and/or salts, or mixtures thereof, are added to the hydrogel in step b) and/or the slurry in step c).

7. The process for preparing the support for catalysts as claimed in claim 1, wherein inorganic hydroxides, oxide-hydroxides, oxides and/or salts are added to the hydrogel in step b) and/or the slurry in step c) in an amount of ≦10% by weight based on the total solids content.

8. The process for preparing the support for catalysts as claimed in claim 1, wherein AlOOH is added to the hydrogel in step b) and/or the slurry in step c) in an amount of from 1% by weight to 30% by weight, based on the total solids content.

9. The process for preparing a support for catalysts as claimed in claim 1, wherein compounds of alkaline earth metals, are added to the hydrogel in step b) and/or the slurry in step c) in an amount of from 1% by weight to 10% by weight, based on the total solids content.

10. The process for preparing the support for catalysts as claimed in claim 1, wherein hydroxyl methyl cellulose is added to the hydrogel in step b) and/or the slurry in step c) in an amount of from 0.1% by weight to 10% by weight, based on the total solids content.

11. The process for preparing the support for catalysts as claimed in claim 1, wherein the solids content of the slurry in step (c) is ≦20% by weight based on the total weight, in step c).

12. The process for preparing the support for catalysts as claimed in claim 1, wherein drying of the slurry comprising the finely particulate hydrogel is carried out by means of spray drying.

13. The process for preparing the support for catalysts as claimed in claim 1, wherein ≦5% by volume of the support particles obtained after drying have a particle size in the range from >0 μm to ≦25 μm, based on the total volume of the particles.

14. The process for preparing the support for catalysts as claimed in claim 1, wherein the support particles produced after drying have a mean particle size in the range from 1 μm to 350 μm.

15. A support for catalysts prepared by a process comprising:
a) preparing a hydrogel;
b) milling the hydrogel to give a finely particulate hydrogel;
c) producing a slurry comprising the finely particulate hydrogel;
d) drying the slurry comprising the finely particulate hydrogel, thereby forming a support for catalysts,
wherein the finely particulate hydrogel comprises:
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm.

16. The support for catalysts as claimed in claim 15 further comprising a silicon content of the support of ≧10% by weight based on the total weight of the support.

17. The support for catalysts as claimed in claim 15 further comprising an aluminum content of the support of ≧10% by weight, based on the total weight of the support.

18. A process comprising preparing a catalyst comprising a support, the support being prepared by a process comprising:
a) preparing a hydrogel;
b) milling the hydrogel to give a finely particulate hydrogel;
c) producing a slurry comprising the finely particulate hydrogel;
d) drying the slurry comprising the finely particulate hydrogel, thereby forming a support for catalysts,
wherein the finely particulate hydrogel comprises:
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm.

19. The process of claim 18 wherein the catalyst is a polymerization or copolymerization catalyst for olefins.

20. The process of claim 3 wherein the solids content of the finely particulate hydrogel is in the range of 8% by weight to 13% by weight.

21. The process of claim 20 wherein the solids content of the finely particulate hydrogel is in the range of 9% by weight to 12% by weight.

22. The process of claim 4 wherein the finely particulate hydrogel comprises at least 50% by volume of the hydrogel particles.

23. The process of claim 5 wherein the particle size range of the finely particulate hydrogel is from >0 μm to ≦2.5 μm.

24. The process of claim 6 wherein the inorganic hydroxides, oxide-hydroxides, oxides and/or salts are selected from the group consisting of SiO₂, Al₂O₃, MgO, AlPO₄, TiO₂, ZrO₂, Cr₂O₃ and mixtures thereof.

25. The process of claim 7 wherein the inorganic hydroxides, oxide-hydroxides, oxides and/or salts are added in an amount of ≦5% by weight.

26. The process of claim 25 wherein the inorganic hydroxides, oxide-hydroxides, oxides and/or salts are added in an amount of ≦2% by weight.

27. The process of claim 8 wherein the AlOOH is added in an amount from 5% by weight to 20% by weight.

28. The process of claim 9 wherein the compounds of alkaline earth metals are selected from the group consisting of Ca(OH)₂ and Mg(OH)₂.

29. The process of claim 9 wherein the compounds of alkaline earth metals are added in an amount from 2% by weight to 4% by weight.

30. The process of claim 10 wherein the hydroxyl methyl cellulose is added in an amount from 1% by weight to 2% by weight.

31. The process of claim 11 wherein the solids content of the slurry in step (c) is ≦15% by weight.

32. The process of claim 31 wherein the solids content of the slurry in step (c) is ≦10% by weight.

33. The process of claim 32 wherein the solids content of the slurry in step (c) is from 8% by weight to 10% by weight.

34. The process of claim 13 wherein ≦2% by volume of the support particles obtained after drying have a particle size in the range from >0 μm to ≦25 μm, based on the total volume of the particles.

35. The process according to claim 14 wherein the support particles have a mean particle size in the range from 30 μm to 150 μm.

36. The process according to claim 35 wherein the support particles have a mean particle size in the range from 40 μm to 100 μm.

37. The process according to claim 16 wherein the silicon content is ≧25% by weight.

38. The process according to claim 37 wherein the silicon content is ≧30% by weight.

39. The process according to claim 38 wherein the silicon content is ≧50% by weight.

40. The process according to claim 17 wherein the aluminum content is ≧25% by weight.

41. The process according to claim 40 wherein the aluminum content is ≧30% by weight.

42. The process according to claim 41 wherein the aluminum content is >50% by weight.
